(19) United States
(12) Patent Application Publication
(10) Pub. No.: US 2017/0115536 A1
(43) Pub. Date: Apr. 27, 2017

(54) DISPLAY DEVICE

(71) Applicant: SAMSUNG DISPLAY CO., LTD., Yongin-si (KR)

(72) Inventors: Dan Bi YANG, Gunpo-si (KR); Dong Han SONG, Hwaseong-si (KR); Min-Joo HAN, Seoul (KR); Ji Phyo HONG, Pyeongtaek-si (KR)

(21) Appl. No.: 15/154,133

(22) Filed: May 13, 2016

(30) Foreign Application Priority Data
Oct. 23, 2015 (KR) 10-2015-0147881

(51) Int. Cl. G02F 1/1343; G02F 1/1337; G02F 1/137; G02F 1/1333; G02F 1/1368

(52) U.S. Cl. CPC G02F 1/134363; G02F 1/133377; G02F 1/1368; G02F 1/133345; G02F 1/137; G02F 1/1337; G02F 1/133305; G02F 2001/134318; G02F 2001/133738

(57) ABSTRACT

A display device according to an exemplary embodiment includes a substrate; a thin film transistor disposed on the substrate; a pixel electrode connected to the thin film transistor; a first common electrode overlapping the pixel electrode via an insulating layer; a second common electrode spaced apart from the first common electrode with a plurality of microcavities therebetween; a roof layer disposed on the second common electrode; a liquid crystal layer including liquid crystal molecules disposed in the microcavities; and an encapsulation layer disposed on the roof layer and sealing the microcavities.

### RELATED APPLICATIONS

This application claims priority to and the benefit of Korean Patent Application No. 10-2015-0147881, filed in the Korean Intellectual Property Office on Oct. 23, 2015, the disclosure of which is incorporated herein by reference in its entirety.

### BACKGROUND

1. Field

The present disclosure relates generally to a display device, and more particularly, to a display device capable of preventing light leakage in a black state.

2. Description of the Related Art

Liquid crystal displays are widely used as one type of flat panel displays. A liquid crystal display has two display panels on which field generating electrodes such as pixel electrodes and a common electrode are formed, and a liquid crystal layer that is interposed between the two display panels. Voltages are applied to the field generating electrodes to generate an electric field over the liquid crystal layer, and the alignment of liquid crystal molecules of the liquid crystal layer is determined by the electric field. Accordingly, the polarization of incident light is controlled, thereby performing image display.

The two display panels forming the liquid crystal display may be a thin film transistor array panel and an opposing display panel. In the thin film transistor array panel, a gate line transmitting a gate signal and a data line transmitting a data signal are formed to cross, and a thin film transistor connected to the gate line and the data line and a pixel electrode connected to the thin film transistor may be formed. A light blocking member, a color filter, a common electrode, etc. may be formed on the opposing display panel or on the thin film transistor array panel.

However, in a conventional liquid crystal display, two substrates are required, and the constituent elements are respectively formed on the two substrates. Resultantly, such a display device is heavy and expensive, and the manufacturing process takes long.

The above information disclosed in this Background section is only to enhance the understanding of the background of the present disclosure, and therefore it may contain information that does not form a prior art that is known to a person of ordinary skill in the art.

### SUMMARY

The present disclosure provides a display device having a reduced weight, thickness, cost, and processing time by manufacturing the display device using one substrate. In addition, a display device capable of preventing light leakage in a black state is provided.

A display device according to an exemplary embodiment includes a substrate; a thin film transistor disposed on the substrate; a pixel electrode connected to the thin film transistor; a first common electrode overlapping the pixel electrode via an insulating layer; a second common electrode spaced apart from the first common electrode with a plurality of microcavities therebetween; a roof layer disposed on the second common electrode; a liquid crystal layer including liquid crystal molecules disposed in the microcavities; and an encapsulation layer disposed on the roof layer and sealing the microcavities.

The first common electrode may be applied with the first common voltage, and the pixel electrode is applied with a data voltage representing a plurality of gray levels including a lowest gray level and a highest gray level.

When the pixel electrode is applied with the data voltage representing the lowest gray level, the second common electrode may be applied with a second common voltage.

When the pixel electrode is applied with the data voltage representing the lowest gray level, the vertical electric field may be formed between the first common electrode and the second common electrode.

When the pixel electrode is applied with the data voltage representing the lowest gray level, the vertical electric field may be formed in the liquid crystal layer.

When the pixel electrode is applied with the data voltage representing the lowest gray level, the liquid crystal molecules of the liquid crystal layer may be aligned in a direction vertical to the substrate.

When the pixel electrode is applied with the data voltage representing a gray level other than the lowest gray level, no voltage is applied to the second common electrode.

When the pixel electrode is applied with the data voltage representing the gray level other than the lowest gray level, a horizontal electric field may be formed between the pixel electrode and the first common electrode.

When the pixel electrode is applied with the data voltage representing the gray level other than the lowest gray level, the horizontal electric field may be formed in the liquid crystal layer.

When the pixel electrode is applied with the data voltage representing the gray level other than the lowest gray level, the liquid crystal molecules of the liquid crystal layer may be aligned in a direction parallel to the substrate.

Before the pixel electrode is applied with the data voltage representing the gray level other than the lowest gray level, the second common electrode may be applied with a second common voltage.

Before the pixel electrode is applied with the data voltage representing the gray level other than the lowest gray level, a vertical electric field may be formed between the first common electrode and the second common electrode.

Before the pixel electrode is applied with the data voltage representing the gray level other than the lowest gray level, a vertical electric field may be formed to the liquid crystal layer.

Before the pixel electrode is applied with the data voltage representing the gray level other than the lowest gray level, the liquid crystal molecules of the liquid crystal layer may be aligned in the direction vertical to the substrate.

The display device according to an exemplary embodiment may further include a first alignment layer disposed on the pixel electrode and a second alignment layer disposed under the second common electrode.

The first alignment layer and the second alignment layer may be made of a horizontal alignment layer.

The first alignment layer and the second alignment layer may be connected to each other within the side wall of the microcavities.

The insulating layer may be disposed on the first common electrode, and the pixel electrode may be disposed on the insulating layer.

The pixel electrode may include a plurality of branch electrode and a slit disposed between the plurality of branch electrodes.

The substrate may be made of a material that can be bent.

The display device according to the exemplary embodiments has the below effect.

According to the exemplary embodiments, the display device is manufactured using one substrate, thereby decreasing the weight, thickness, cost, and processing time of the display device.

In addition, by forming a vertical electric field in a black state, light leakage may be prevented.

### BRIEF DESCRIPTION OF THE DRAWINGS

FIG. 1 is a top plan view of a display device, according to an exemplary embodiment.

FIG. 2 is a layout view showing a part of a display device, according to an exemplary embodiment.

FIG. 3 is a cross-sectional view of a display device, according to an exemplary embodiment of FIG. 2 taken along line III-III.

FIG. 4 is a cross-sectional view of a display device, according to an exemplary embodiment of FIG. 2 taken along line IV-IV.

FIG. 5 is a view showing an alignment direction of liquid crystal molecules in an initial state.

FIG. 6 is a view showing an alignment direction of liquid crystal molecules when bending a substrate in an initial state.

FIG. 7 is a view showing an alignment direction of liquid crystal molecules when being driven to represent a lowest gray level.

FIG. 8 is a view showing an alignment direction of liquid crystal molecules when being driven to represent a gray level other than a lowest gray level.

FIG. 9 is a simulation result showing an alignment state when a display device, according to a reference example represents a lowest gray level.

FIG. 10 is a graph showing a luminance depending on a position when a display device, according to a reference example represents a lowest gray level.

FIG. 11 is a simulation result of an alignment state when a display device, according to an exemplary embodiment represents a lowest gray level.

FIG. 12 is a graph showing luminance depending on a position when a display device, according to an exemplary embodiment represents a lowest gray level.

### DETAILED DESCRIPTION

The present disclosure will be described more fully hereinafter with reference to the accompanying drawings, in which exemplary embodiments of the present disclosure are shown. As those skilled in the art would realize, the described embodiments may be modified in various different ways, all without departing from the spirit or scope of the present disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or one or more intervening elements may also be present. In contrast, when an element is referred to as being “directly on” another element, there may be no intervening elements present.

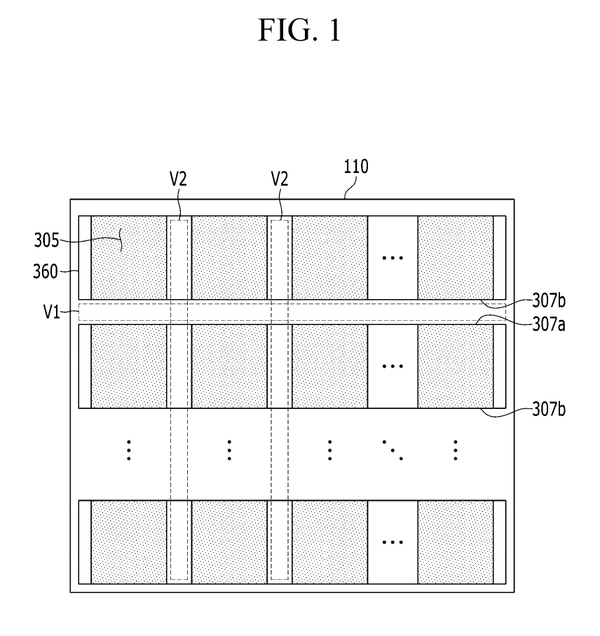

First, a display device according to an exemplary embodiment will be described with reference to FIG. 1. FIG. 1 is a top plan view of a display device, according to an exemplary embodiment.

As shown in FIG. 1, the display device according to an exemplary embodiment includes a substrate 110 made of a material such as glass or plastic. Microcavities 305 are disposed on the substrate 110 and covered by a roof layer 360. The roof layer 360 is extended in a row direction, and a plurality of microcavities 305 are disposed under the roof layer 360. However, the present disclosure is not limited thereto, and the roof layer 360 may be extended in a column direction.

The microcavities 305 may be arranged in a matrix form, and a first region V1 is disposed between the vertically adjacent microcavities 305, while a second region V2 is disposed between the horizontally adjacent microcavities 305. The first region V1 is disposed between a plurality of roof layers 360. The microcavities 305 may not be covered by the roof layer 360 but may be exposed to the outside at portions that contact the first region V1. These portions are referred to as injection holes 307a and 307b.

The injection holes 307a and 307b are disposed at both edges of each microcavity 305. The injection holes 307a and 307b include a first injection hole 307a and a second injection hole 307b, and the first injection hole 307a is formed to expose a lateral surface of a first edge of the microcavity 305, while the second injection hole 307b is formed to expose a lateral surface of a second edge of the microcavity 305. The lateral surface of the first edge and the lateral surface of the second edge of the adjacent microcavities 305 face each other.

Each roof layer 360 is disposed to be separated from the substrate 110 between the adjacent second regions V2, thereby forming the microcavities 305. That is, the roof layer 360 is formed to cover the lateral surface other than the lateral surface of the first edge and the second edge formed with the injection holes 307a and 307b.

The aforementioned structure of the display device according to the exemplary embodiment is just an example, and various modifications are feasible. For example, the microcavity 305, the first region V1, and the second region V2 may be arranged differently, the plurality of roof layers 360 may be connected to each other in the first region V1, and a portion of each roof layer 360 may be formed to be spaced apart from the substrate 110 in the second region V2 to connect the adjacent microcavities 305 to each other.

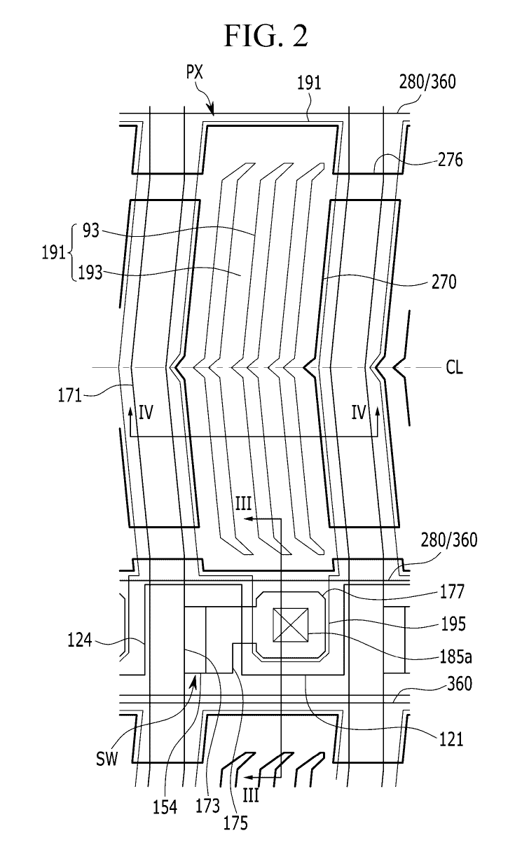

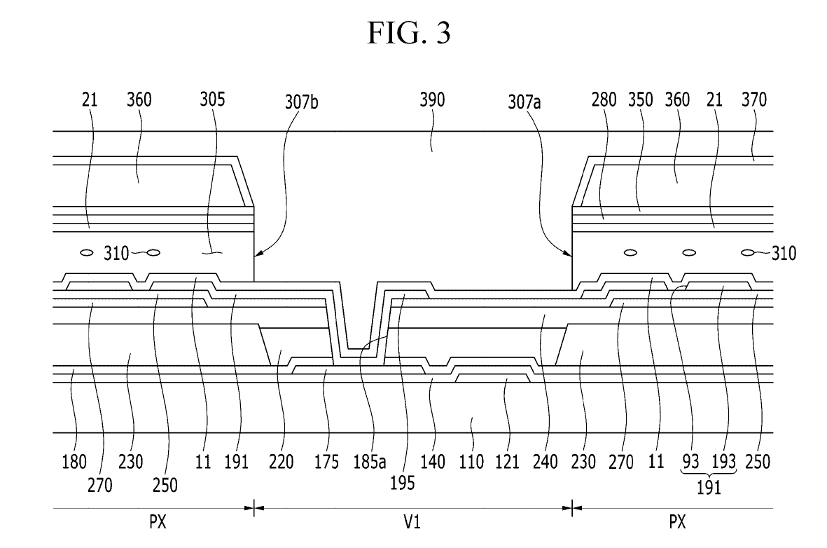

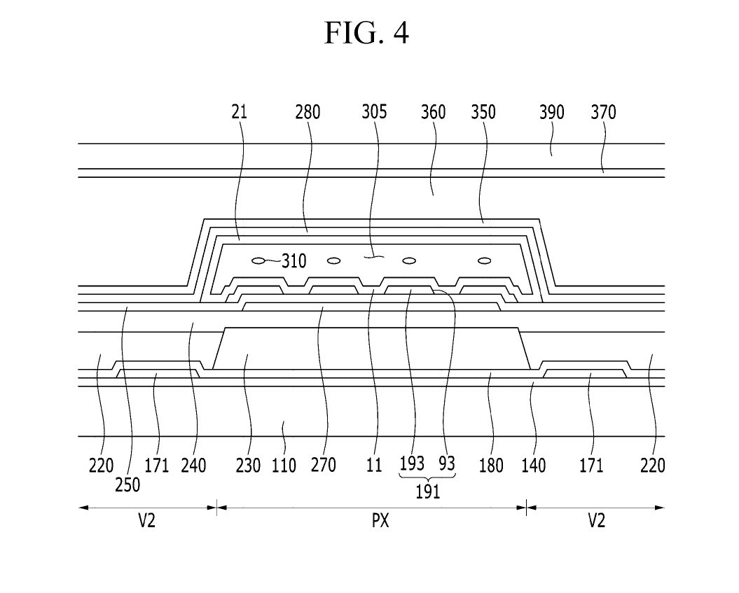

Hereinafter, one pixel of the display device according to an exemplary embodiment will be described with reference to FIG. 2 to FIG. 4. FIG. 2 is a layout view showing a part of a display device, according to an exemplary embodiment, FIG. 3 is a cross-sectional view of a display device according to an exemplary embodiment of FIG. 2 taken along line III-III, and FIG. 4 is a cross-sectional view of a display device according to an exemplary embodiment of FIG. 2 taken along line IV-IV.

Referring to FIG. 2 to FIG. 4, a gate line 121 and a gate electrode 124 protruding from the gate line 121 are formed on the insulation substrate 110. The substrate 110 is made of a transparent material that is bent such as glass, plastic, and the like. By bending the substrate 110 after forming all the constituent elements on the substrate 110, a curved display device may be formed.

The gate line 121 may mainly extend in a horizontal direction, and transmits a gate signal. The gate line 121 may be formed between the microcavities 305 that are adjacent in a column direction. That is, the gate line 121 may be formed in the first region V1.

A gate insulating layer 140 is disposed on the gate line 121 and the gate electrode 124. The gate insulating layer 140 may be made of an inorganic insulating material such as silicon nitride (SiNx) and silicon oxide (SiOx). In addition, the gate insulating layer 140 may be formed of a single layer or multiple layers.

A semiconductor 154 is disposed on the gate insulating layer 140. The semiconductor 154 may be formed on the gate electrode 124. In some embodiments, the semiconductor 154 may also be formed under the data line 171. The semiconductor 154 may be formed of amorphous silicon, polycrystalline silicon, or a metal oxide.

An ohmic contact (not shown) may be further formed on the semiconductor 154. The ohmic contact may be made of a silicide or of n+ hydrogenated amorphous silicon doped with an n-type impurity at a high concentration.

A data line 171 and a drain electrode 175 separated from the data line 171 are formed on the semiconductor 154 and the gate insulating layer 140. The data line 171 includes a source electrode 173, and the source electrode 173 and the drain electrode 175 are formed to face each other.

The data line 171 transmits a data signal and mainly extends in a vertical direction, thereby crossing the gate line 121. The data line 171 is formed between the microcavities 305 that are adjacent in the row direction. That is, the data line 171 is formed in the second region V2. The data line 171 may be periodically curved. For example, as illustrated in FIG. 2, each data line 171 may be curved at least once at a portion corresponding to a horizontal center line CL of one pixel PX.

As shown in FIG. 2, the source electrode 173 does not protrude from the data line 171, and may be formed on the same line as the data line 171. The drain electrode 175 may include a rod-shaped portion extending substantially parallel to the source electrode 173, and an extension 177 that is opposite to the rod-shaped portion.

The gate electrode 124, the source electrode 173, and the drain electrode 175 form a thin film transistor (TFT) together with the semiconductor 154. The thin film transistor may function as a switching element SW for transmitting a data voltage of the data line 171. In this case, a channel of the switching element SW is formed in the semiconductor 154 between the source electrode 173 and the drain electrode 175.

A passivation layer 180 is formed on the data line 171, the source electrode 173, the drain electrode 175, and the exposed portion of the semiconductor 154. The passivation layer 180 may be made of an organic insulating material or inorganic insulating material, and may be formed of a single layer or multiple layers.

Color filters 230 are formed in each pixel PX on the passivation layer 180.

Each color filter 230 may display one of the primary colors, red, green, and blue. The color filter 230 is not limited to these primary colors of red, green, and blue, and may also display one of cyan, magenta, yellow, and white-based colors. The color filter 230 may not be formed at the first region V1 and/or the second region V2.

A light blocking member 220 is formed at a region between adjacent color filters 230. The light blocking member 220 is formed on a boundary of the pixel PX and the switching element to prevent light leakage. That is, the light blocking member 220 may be formed in the first region V1 and the second region V2. However, the present exemplary embodiment is not limited thereto, and the light blocking member 220 may be formed only in the first region V1 and not in the second region V2. In this case, in the second region V2, the color filters 230 may overlap with each other within the adjacent pixels PX. The color filters 230 and the light blocking member 220 may overlap with each other in a partial region.

A first insulating layer 240 may be further formed on the color filters 230 and the light blocking member 220. The first insulating layer 240 may be formed of an organic insulating material, and may serve to planarize the upper surface of each color filter 230 and the light blocking member 220. The first insulating layer 240 may be made of a dual layer including a first layer made of an organic insulating material and a second layer made of an inorganic insulating material. In some embodiments, the first insulating layer 240 may be omitted.

A first common electrode 270 is disposed on the first insulating layer 240. Adjacent first common electrodes 270 formed in the plurality of pixels PX are connected to each other through a connection bridge 276 and the like to transfer substantially the same voltage. The first common electrode 270 formed in each pixel PX may be made of a planar shape. The first common electrode 270 may be made of a transparent metal oxide such as indium-tin oxide (ITO) and indium-zinc oxide (IZO). The first common electrode 270 may be applied with a first common voltage. The first common voltage may be a predetermined voltage.

A second insulating layer 250 is disposed on the first common electrode 270. The second insulating layer 250 may be made of an inorganic insulating material such as silicon nitride (SiNx) and silicon oxide (SiOx).

The passivation layer 180, the first insulating layer 240, and the second insulating layer 250 have a contact hole 185a exposing a part of the drain electrode 175, for example, the expansion 177.

A pixel electrode 191 is disposed on the second insulating layer 250. The pixel electrode 191 may include a plurality of branch electrodes 193 and a slit 93 formed between the plurality of branch electrodes 193. The plurality of branch electrodes 193 of the pixel electrode 191 overlap the first common electrode 270. The pixel electrode 191 and the first common electrode 270 are separated by the second insulating layer 250. The second insulating layer 250 functions to insulate the pixel electrode 191 and the first common electrode 270.

The pixel electrode 191 may include a protrusion 195 for connection with other layers. The protrusion 195 of the pixel electrode 191 is physically and electrically connected to the drain electrode 175 through the contact hole 185a, thereby receiving the voltage from the drain electrode 175. The pixel electrode 191 may be made of a transparent metal oxide such as indium-tin oxide (ITO) and indium-zinc oxide (IZO).

The pixel electrode 191 may include an edge that is curved along the curved shape of the data line 171. For example, the pixel electrode 191 may be formed as a polygon including an edge that is bent at least one time at the portion corresponding to the transverse center line CL of the pixel PX.

The pixel electrode 191 is applied with a data voltage. The data voltage is transmitted to the pixel electrode 191 through the data line 171 when the switching element SW is turned on. The data voltage may represent one of a plurality of gray levels ranging from a lowest gray level to a highest gray level. For example, the lowest gray level may be 0, the highest gray level may be 61, and a total of 62 gray levels may exist between the lowest gray level and the highest gray level.

The arrangement of the above-described pixel and the shape of the thin film transistor may vary. In addition, the positions of the pixel electrode 191 and the first common electrode 270 may be exchanged. That is, the second insulating layer 250 is disposed on the first common electrode 270, and the pixel electrode 191 is disposed on the second insulating layer 250, however the insulating layer may be disposed on the pixel electrode and the common electrode may be disposed on the insulating layer. In addition, the pixel electrode 191 may be made in a planar shape, and the first common electrode 270 may include the branch electrodes 193 and the slit 93.

A second common electrode 280 that is separated from the pixel electrode 191 by a predetermined distance is formed on the pixel electrode 191. The microcavities 305 are disposed between the pixel electrode 191 and the second common electrode 280. That is, the microcavities 305 are enclosed by the pixel electrode 191 and the second common electrode 280. The second common electrode 280 extends in a row direction and is formed on the microcavities 305 and in the second region V2. The second common electrode 280 is disposed to cover the upper surface and the lateral surface of the microcavities 305. The size of the microcavities 305 may vary depending on the size and the resolution of the display device.

The second common electrode 280 may be made of a transparent metal oxide such as indium-tin oxide (ITO) and indium-zinc oxide (IZO). The second common electrode 280 may be applied with a second common voltage. The second common voltage may be a predetermined voltage. An electric field may be generated between the first common electrode 270 and the second common electrode 280.

Alignment layers are disposed on the pixel electrode 191 and below the second common electrode 280. The alignment layers include a first alignment layer 11 and a second alignment layer 21. The first alignment layer 11 and the second alignment layer 21 may be horizontal alignment layers and may be formed of an alignment material such as polyamic acid, polysiloxane, and polyimide. The first and second alignment layers 11 and 21 may be connected at the lateral wall of the edge of the microcavity 305.

The first alignment layer 11 is disposed on the pixel electrode 191. The first alignment layer 11 may be disposed directly on the second passivation layer 240 that is not covered by the pixel electrode 191. In addition, the first alignment layer 11 may be also disposed in the first region V1. The second alignment layer 21 is disposed under the second common electrode 280 to face the first alignment layer 11.

A liquid crystal layer made of liquid crystal molecules 310 is formed in the microcavity 305 formed between the pixel electrode 191 and the second common electrode 280. The liquid crystal molecules 310 may have positive dielectric anisotropy or negative dielectric anisotropy. The liquid crystal molecules 310 may be arranged such that a long axis direction thereof is aligned parallel to the substrate 110 in the absence of an electric field. That is, the horizontal alignment may be realized.

The pixel electrode 191 applied with a data voltage through the switching element SW generates a corresponding electric field along with the first common electrode 270 applied with the first common voltage to determine an alignment direction of the liquid crystal molecules 310 of the liquid crystal layer. Particularly, the branch electrodes 193 of the pixel electrode 191 form a fringe field to the liquid crystal layer along with the first common electrode 270, thereby determining the alignment direction of the liquid crystal molecules 310. As such, luminance of light passing through the liquid crystal layer varies according to the determined alignment direction of the liquid crystal molecules 310, thereby displaying an image.

When the pixel electrode 191 is applied with a data voltage representing the lowest gray level (i.e., black), the second common electrode 280 is applied with the second common voltage. In this case, the vertical electric field is generated between the first common electrode 270 applied with the first common voltage and the second common electrode 280 applied with the second common voltage. Accordingly, the vertical electric field is formed on the liquid crystal layer formed between the first common electrode 270 and the second common electrode 280, and the liquid crystal molecules 310 in the liquid crystal layer are aligned in a direction vertical to the substrate 110. If the liquid crystal molecules 310 are aligned in the direction vertical to the substrate 110, the lowest gray level may be expressed without light leakage.

When a data voltage representing a gray level other than the lowest gray level is applied to the pixel electrode 191, no voltage may be applied to the second common electrode 280. In this case, the horizontal electric field is formed between the pixel electrode 191 and the first common electrode 270. Accordingly, the horizontal electric field is formed on the liquid crystal layer, thereby the liquid crystal molecules 310 in the liquid crystal layer are aligned in a direction parallel to the substrate 110. The liquid crystal molecules 310 are aligned in the direction parallel to the substrate 110, thereby expressing a predetermined gray level along the direction of the liquid crystal molecules 310.

In the foregoing description, the second common electrode 280 is applied with a predetermined voltage only when representing the lowest gray level to form the vertical electric field on the liquid crystal layer, and when representing a gray level other than the lowest gray level, no voltage is applied to the second common electrode 280. However, the present disclosure is not limited thereto.

When representing a gray level other than the lowest gray level, a predetermined voltage may also be applied to the second common electrode 280 during an initial driving of the pixel. For example, the second common voltage may be applied to the second common electrode 280 directly before applying the data voltage representing the gray level other than the lowest gray level to the pixel electrode 191. In this case, the vertical electric field is formed between the first common electrode 270 and the second common electrode 280. Accordingly, the vertical electric field is formed on the liquid crystal layer, and the liquid crystal molecules 310 in the liquid crystal layer are aligned in a direction vertical to the substrate 110. When representing the gray level other than the lowest gray level, the liquid crystal molecules are initially aligned in the direction vertical to the substrate 110 and then are aligned in the direction parallel to the substrate 110 to express a predetermined gray level, thereby improving the response speed. This is more advantageous in terms of the response speed where the liquid crystal molecules are aligned in a direction parallel to the substrate 110 in a state in which the liquid crystal molecules are vertically aligned rather than being horizontally aligned to express the predetermined gray level in the state in which the liquid crystal molecules are horizontally aligned.

A third insulating layer 350 may be further formed on the second common electrode 280. The third insulating layer 350 may be made of an inorganic insulating material such as silicon nitride (SiNx) and silicon oxide (SiOx), and may be omitted in some embodiments.

A roof layer 360 is formed on the third insulating layer 350. The roof layer 360 may be formed of an organic material. The roof layer 360 is formed in a row direction and is disposed on the microcavity 305 and at the second valley V2. The roof layer 360 is formed to cover the upper surface of a part of the lateral surface of the microcavity 305. The roof layer 360 may be hardened by a hardening process to maintain the shape of the microcavity 305. That is, the roof layer 360 is formed to be spaced apart from the pixel electrode 191 with the microcavity 305 interposed therebetween.

The second common electrode 280 and the roof layer 360 are formed to not cover a part of the lateral side at the edge of the microcavity 305, and the portions of the microcavity 305 that are not covered by the common electrode 270 and the roof layer 360 are referred to as injection holes. The injection holes include a first injection hole 307a for exposing the lateral surface at the first edge of the microcavity 305 and a second injection hole 307b for exposing the lateral surface at the second edge of the microcavity 305. The first edge faces the second edge, and for example, the first edge may be an upper edge of the microcavity 305 and the second edge may be a lower edge of the microcavity 305 in a plan view. The microcavity 305 is exposed by the injection holes 307a and 307b in the manufacturing process of a display device so that an aligning agent or a liquid crystal material may be injected into the microcavity 305 through the injection holes 307a and 307b.

A fourth insulating layer 370 may be further formed on the roof layer 360. The fourth insulating layer 370 may be made of an inorganic insulating material such as a silicon nitride (SiNx) or a silicon oxide (SiOx). The fourth insulating layer 370 may be formed to cover the upper surface and/or the lateral surface of the roof layer 360. The fourth insulating layer 370 protects the roof layer 360 made of an organic material, and it may be omitted in some embodiments.

An encapsulation layer 390 is formed on the fourth insulating layer 370. The encapsulation layer 390 is formed to cover the injection holes 307a and 307b exposing a part of the microcavity 305 to the outside. That is, the encapsulation layer 390 may seal the microcavity 305 to prevent the liquid crystal molecules 310 formed inside the microcavity 305 from leaking to the outside. The encapsulation layer 390 contacts the liquid crystal molecules 310, and the encapsulation layer 390 is made of a material that does not react with the liquid crystal molecules 310. For example, the encapsulation layer 390 may be made of parylene or the like.

The encapsulation layer 390 may include multiple layers such as a double layer and a triple layer. The double layer including two layers may be made of different materials. The triple layer including three layers, and the materials of adjacent layers are different from each other. For example, the encapsulation layer 390 may include a first layer that is made of an organic insulating material and a second layer that is made of an inorganic insulating material.

Although not shown, a polarizer may be further formed on the upper face and the lower surface of the display device. The polarizer may include a first polarizer and a second polarizer. The first polarizer may be attached on the lower surface of the substrate 110, and the second polarizer may be attached on the encapsulation layer 390.

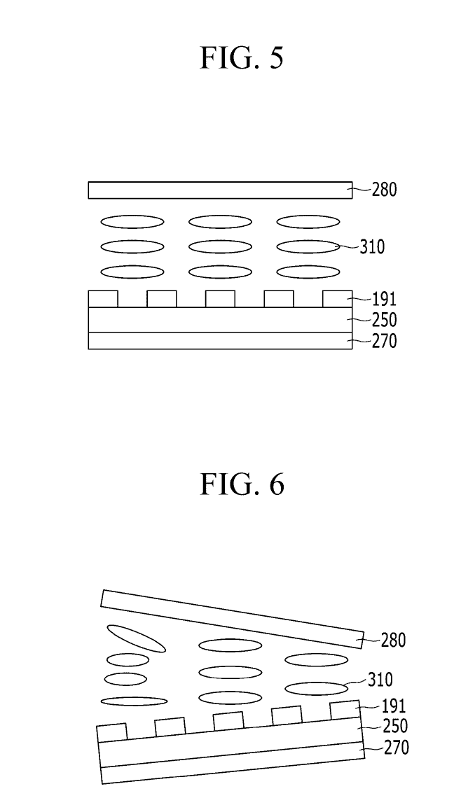

Next, an initial state of the display device according to an exemplary embodiment and the alignment direction of the liquid crystal molecule when being driven will be described with reference to FIG. 5 to FIG. 8.

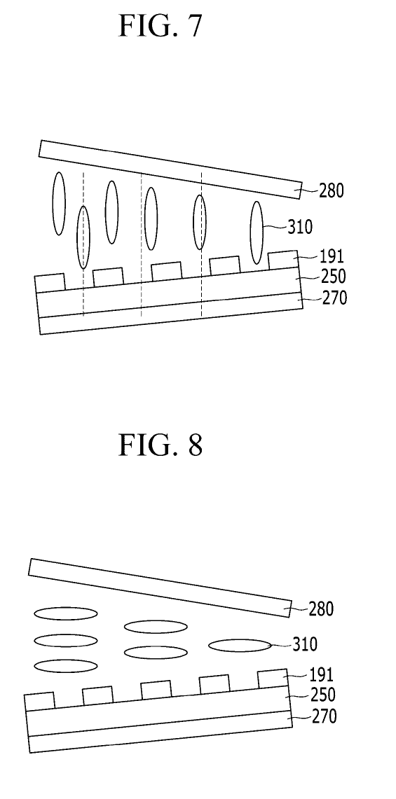

FIG. 5 is a view showing an alignment direction of liquid crystal molecules in an initial state, and FIG. 6 is a view showing an alignment direction of liquid crystal molecules when bending a substrate in an initial state. FIG. 7 is a view showing an alignment direction of liquid crystal molecules when being driven to represent a lowest gray level, and FIG. 8 is a view showing an alignment direction of liquid crystal molecules when being driven to represent a gray level other than a lowest gray level. FIG. 5 to FIG. 8 are the cross-sectional views schematically showing the partial constituent elements of the display device. FIG. 5 to FIG. 8 only show the pixel electrode, the second insulating layer, the first common electrode, the liquid crystal molecule, and the second common electrode, and other constituent elements are omitted from illustration.

As shown in FIG. 5, in the initial state, the liquid crystal molecules 310 are aligned in the horizontal direction. The alignment layer is made of the horizontal alignment layer, and no voltage is applied to the pixel electrode 191, the first common electrode 270, and the second common electrode 280 in the initial state.

As shown in FIG. 6, when bending the display device in the initial state to form the curved display device, the alignment state of the liquid crystal molecules 310 in the liquid crystal layer is disturbed. Particularly, strains of the alignment state are generated the most on the edge part of the microcavities. Light leakage may be generated by the deformation of the alignment state of the liquid crystal molecules 310. Furthermore, an aggregation phenomenon of the alignment layer may be generated on the edge part in the microcavities, thereby generating light leakage.

As shown in FIG. 7, when driving the display device to represent the lowest gray level, the vertical electric field is formed between the first common electrode 270 and the second common electrode 280 to align the liquid crystal molecules 310 in the liquid crystal layer in the vertical direction. An electric field is formed in the vertical direction by the first common voltage that is applied to the first common electrode 270 and the second common voltage that is applied to the second common electrode 280. The difference between the first common voltage and the second common voltage must be more than a minimum voltage to move the liquid crystal molecules 310 that are aligned in the horizontal direction into the vertical direction. By aligning the liquid crystal molecules 310 in the vertical direction when expressing the lowest gray level, light leakage may be prevented on the edge part of the microcavities.

As shown in FIG. 8, when driving the display device to express a gray level other than the lowest gray level, no voltage is applied to the second common electrode 280. A horizontal electric field is formed between the pixel electrode 191 and the first common electrode 270. The liquid crystal molecules 310 are aligned in the horizontal direction, thereby expressing a predetermined gray level along the direction of the liquid crystal molecules 310.

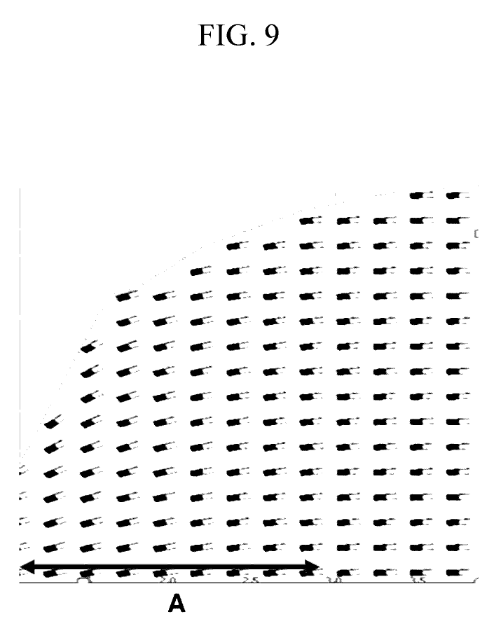

Hereinafter, the luminance in the lowest gray level of the display device according to an exemplary embodiment will be described with reference to FIG. 9 to FIG. 12. The exemplary embodiment is described in comparison with the luminance in the lowest gray level of the display device according to a reference example.

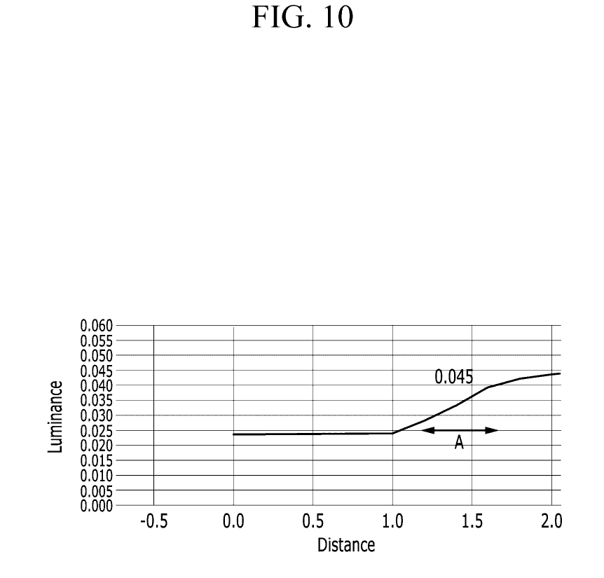

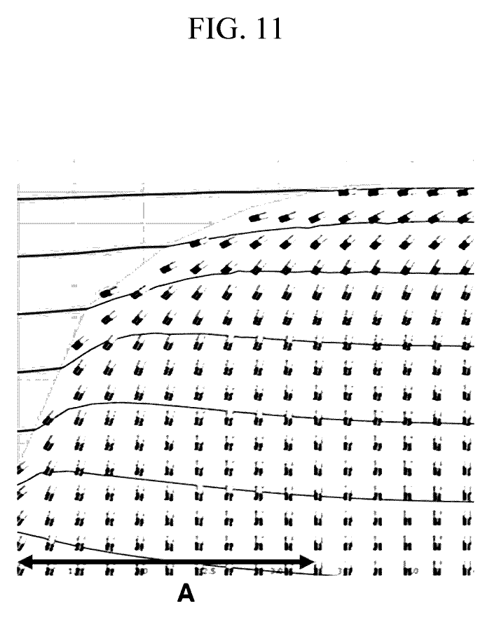

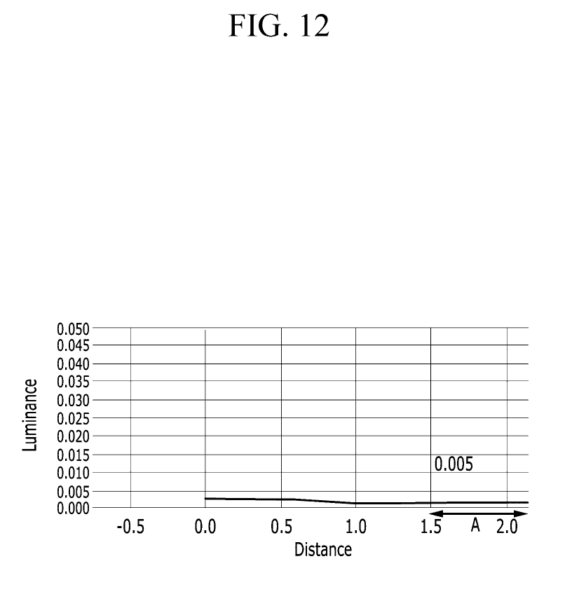

FIG. 9 is a simulation result showing an alignment state when a display device, according to a reference example represents a lowest gray level, and FIG. 10 is a graph showing luminance depending on a position when a display device, according to a reference example represents a lowest gray level. FIG. 11 is a simulation result of an alignment state when a display device, according to an exemplary embodiment represents a lowest gray level, and FIG. 12 is a graph showing luminance depending on a position when a display device, according to an exemplary embodiment represents a lowest gray level. FIG. 10 and FIG. 12 are graphs showing a relative luminance depending on a relative distance from a center of the microcavity.

In the case of the display device according to the reference example, the second common electrode does not exist differently from the display device according to an exemplary embodiment. Accordingly, only the horizontal electric field is formed from the pixel electrode and the first common electrode, and the vertical electric field is not formed.

As shown in FIG. 9, in the case of the display device according to the reference example, when displaying the lowest gray level, the liquid crystal molecules are aligned in the horizontal direction. In this case, if the display device is bent to form a curved display device, the alignment stage may be changed in region A at the edge of the microcavity. Light leakage may be generated by such a distortion.

As shown in FIG. 10, luminance of about 0.025 appears on the center of the microcavity, and the luminance is increased closer to the edge of the microcavity. In region A, the luminance is increased to about 0.045.

As shown in FIG. 11, in the display device, according to the present exemplary embodiment, when displaying the lowest gray level, the liquid crystal molecules are aligned in the vertical direction. In this case, although the display device is bent to form a curved display device, since the liquid crystal molecules are aligned in the vertical direction in region A at the edge of the microcavity, hardly any light leakage occurs.

As shown in FIG. 12, luminance of less than about 0.005 occurs irrespective of the position. Accordingly, no light leakage occurs in region A. In addition, lower luminance compared to the reference example appears in region A as well as in the entire region. That is, by forming the vertical electric field between the first common electrode and the second common electrode to express the lowest gray level to prevent light leakage, a black color of a very low luminance can be displayed.

While the present disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 110: substrate | 121: gate line |
| 171: data line | 191: pixel electrode |
| 193: branch electrode | 270: first common electrode |
| 280: second common electrode | 305: microcavities |
| 307a, 307b: injection hole | 310: liquid crystal molecule |
| 360: roof layer | 390: encapsulation layer |

What is claimed is:

1. A display device comprising:
a substrate;
a thin film transistor disposed on the substrate;
a pixel electrode connected to the thin film transistor;
a first common electrode overlapping the pixel electrode via an insulating layer;
a second common electrode spaced apart from the first common electrode with a plurality of microcavities therebetween;
a roof layer disposed on the second common electrode;
a liquid crystal layer including liquid crystal molecules disposed in the plurality of microcavities; and
an encapsulation layer disposed on the roof layer to seal the microcavities.

2. The display device of claim 1, wherein:
the first common electrode is applied with a first common voltage, and
the pixel electrode is applied with a data voltage representing a plurality of gray levels, including a lowest gray level and a highest gray level.

3. The display device of claim 2, wherein:
when the pixel electrode is applied with the data voltage representing the lowest gray level, the second common electrode is applied with a second common voltage.

4. The display device of claim 3, wherein:
when the pixel electrode is applied with the data voltage representing the lowest gray level, a vertical electric field is formed between the first common electrode and the second common electrode.

5. The display device of claim 3, wherein:
when the pixel electrode is applied with the data voltage representing the lowest gray level, a vertical electric field is formed to the liquid crystal layer.

6. The display device of claim 3, wherein:
when the pixel electrode is applied with the data voltage representing the lowest gray level, the liquid crystal molecules of the liquid crystal layer are aligned in a direction vertical to the substrate.

7. The display device of claim 3, wherein:
when the pixel electrode is applied with the data voltage representing a gray level other than the lowest gray level, no voltage is applied to the second common electrode.

8. The display device of claim 7, wherein:
when the pixel electrode is applied with the data voltage representing the gray level other than the lowest gray level, a horizontal electric field is formed between the pixel electrode and the first common electrode.

9. The display device of claim 7, wherein:
when the pixel electrode is applied with the data voltage representing the gray level other than the lowest gray level, a horizontal electric field is formed in the liquid crystal layer.

10. The display device of claim 7, wherein:
when the pixel electrode is applied with the data voltage representing the gray level other than the lowest gray level, the liquid crystal molecules of the liquid crystal layer are aligned in a direction parallel to the substrate.

11. The display device of claim 2, wherein:
before the pixel electrode is applied with the data voltage representing a gray level other than the lowest gray level, the second common electrode is applied with a second common voltage.

12. The display device of claim 11, wherein:
before the pixel electrode is applied with the data voltage representing the gray level other than the lowest gray level, a vertical electric field is formed between the first common electrode and the second common electrode.

13. The display device of claim 11, wherein:
before the pixel electrode is applied with the data voltage representing the gray level other than the lowest gray level, a vertical electric field is formed in the liquid crystal layer.

14. The display device of claim 11, wherein:
before the pixel electrode is applied with the data voltage representing the gray level other than the lowest gray level, the liquid crystal molecules of the liquid crystal layer are aligned in a direction vertical to the substrate.

15. The display device of claim 1, further comprising:
a first alignment layer disposed on the pixel electrode; and
a second alignment layer disposed under the second common electrode.

16. The display device of claim 15, wherein:
the first alignment layer and the second alignment layer are made of a horizontal alignment layer.

17. The display device of claim 16, wherein:
the first alignment layer and the second alignment layer are connected to each other within a side wall of the microcavities.

18. The display device of claim 1, wherein:
the insulating layer is disposed on the first common electrode, and
the pixel electrode is disposed on the insulating layer.

19. The display device of claim 18, wherein:
the pixel electrode includes a plurality of branch electrodes and a slit disposed between the plurality of branch electrodes.

20. The display device of claim 1, wherein:
the substrate is made of a material that can be bent.
